(19) United States
(12) Patent Application Publication
(10) Pub. No.: US 2023/0141750 A1
(43) Pub. Date: May 11, 2023

(54) METHOD FOR MANUFACTURING FUEL CELL SEPARATOR HAVING MINIMIZED SURFACE DEFECT VIA SURFACE POLISHING USING HIGH-PRESSURE INJECTION

(71) Applicant: SEJONG EV Co., LTD., Chungju-si (KR)

(72) Inventors: Yoo Taek JEON, Chungju-si (KR); Byung Hak JHUNG, Chungju-si (KR); Won Do KIM, Chungju-si (KR); Heon HEO, Chungju-si (KR); Jae Yeol LEE, Chungju-si (KR)

(21) Appl. No.: 17/981,843

(22) Filed: Nov. 7, 2022

(30) Foreign Application Priority Data
Nov. 5, 2021 (KR) 10-2021-0151587

(51) Int. Cl. H01M 8/0267

(52) U.S. Cl. CPC H01M 8/0267

(57) ABSTRACT

Disclosed is a method for manufacturing a fuel cell separator having minimized surface defect via surface polishing using high-pressure injection, in which surface polishing is performed using a high-pressure injection scheme in which polishing-fluid is injected at high-pressure through a polishing-fluid injection nozzle before performing vision inspection, thereby minimizing the surface defect of the fuel cell separator.

### CROSS-REFERENCE TO RELATED APPLICATION

This application claims a benefit under 35 U.S.C. § 119(a) of Korean Patent Application No. 10-2021-0151587 filed on Nov. 5, 2021, on the Korean Intellectual Property Office, the entirety of disclosure of which is incorporated herein by reference for all purposes.

### FIELD

The present disclosure relates to a method for manufacturing a fuel cell separator having minimized surface defects via surface polishing using high-pressure injection. More specifically, the present disclosure relates to a method for manufacturing a fuel cell separator having minimized surface defects via surface polishing using high-pressure injection, in which surface polishing is performed using a high-pressure injection scheme in which polishing-fluid is injected at high-pressure through a polishing-fluid injection nozzle before performing vision inspection, thereby minimizing the surface defect of the fuel cell separator.

### DESCRIPTION OF RELATED ART

A fuel cell is a device that electrochemically generates electricity using hydrogen gas and oxygen gas. The fuel cell converts hydrogen and air continuously supplied from an outside into electrical energy and thermal energy directly via an electrochemical reaction.

This fuel cell generates electric power using an oxidation reaction at an anode and a reduction reaction at a cathode. In this regard, a membrane-electrode assembly (MEA) composed of a polymer electrolyte membrane and a catalyst layer including platinum or platinum-ruthenium to promote the oxidation and reduction reactions may be used, and a separator made of a conductive material may be coupled to each of both opposing sides of the membrane-electrode assembly to form a cell structure.

Since a unit cell of the fuel cell has a low voltage and thus is not practical, several to hundreds of unit cells are stacked to form a stack which is used. When the unit cells are stacked, a fuel cell separator serves to make an electrical connection between the unit cells and to separate a reaction gas.

In this fuel cell separator, a reaction gas channel and a cooling water channel are formed in an inner area of a rectangular metal plate, and a gasket surrounding the channels is formed. A combination of the reaction gas channel and the cooling water channel is usually referred to as a channel. In general, the reaction gas channel is formed in the front face of the metal plate so as to protrude toward a back face of the metal plate using a stamping process, and the cooling water channel is formed between the reaction gas channels and in the rear face of the metal plate. In a structure of the channel, the reaction gas flows on the front face of the metal plate and the cooling water flows on the rear face of the metal plate. In this regard, the front face of the metal plate is referred to as a reaction gas flow face, and the rear face of the metal plate is referred to as a cooling water flow face.

The above-mentioned conventional fuel cell separator has a water-cooled separator structure. The cooling water flowing into a cooling water inlet manifold defined in one side of the channel flows in the cooling water channel to cool heat generated due to activation loss, a reduction reaction at the anode, and Joule heating during fuel cell operation. The cooling water that has undergone this cooling process is then discharged out of the separator through a cooling water discharge manifold defined in the other side of the channel

The conventional fuel cell separator is manufactured by defining the reaction gas channel and the cooling water channel in the metal plate, and attaching the gasket surrounding the channels thereto. Then, surface defects such as burrs, stains, dents, and scratches are identified using naked-eye based inspection. However, the naked-eye inspection may not secure reliability and may take a lot of time and a quality check cost.

To solve this problem, recently, the surface defects such as burrs, stains, dents, and scratches of fuel cell separators are discriminated using vision inspection using a vision camera.

However, because the conventional fuel cell separator is made of a metal, a surface thereof has high gloss and reflects light therefrom. Thus, the vision camera may not reliably detect the surface defects such as burrs, stains, dents, and scratches. Accordingly, the vision inspection can find a large size dent, but cannot find a fine dent of a size of 30 μm or smaller, and the inspection process time is too long.

In addition, in the conventional fuel cell separator, a surface defect such as a burr occurs due to the gasket surrounding the reaction gas channel and the cooling water channel is made of a rubber material such as EPDM (ethylene propylene diene monomer). For this reason, in a process of washing the conventional fuel cell separator and drying the separator with an air gun, a rubber piece resulting from the burr may fly and adhere to the surface of the fuel cell separator.

A related prior document includes Korean Patent Application Publication No. 10-2003-0060668 (published on Jul. 16, 2003) which describes a separator having a micro fluid-channel and a method for manufacturing the same.

### DISCLOSURE

### Technical Purpose

A purpose of the present disclosure is to provide a method for manufacturing a fuel cell separator having minimized surface defects via surface polishing using high-pressure injection, in which surface polishing is performed using a high-pressure injection scheme in which polishing-fluid is injected at high-pressure through a polishing-fluid injection nozzle before performing vision inspection, thereby minimizing the surface defect of the fuel cell separator.

### Technical Solution

One aspect of the present disclosure provides a method for manufacturing a fuel cell separator having minimized surface defect via surface polishing using high-pressure injection, the method comprising: (a) shaping a fuel cell separator body to form a reaction gas channel and a cooling water channel defined in the body; (b) performing gasket injection molding on the fuel cell separator body having the reaction gas channel and the cooling water channel defined therein such that a gasket is attached to and disposed along an edge of the fuel cell separator body; (c) performing high-pressure injection based surface-polishing using a high-pressure injection based surface-polishing apparatus to inject a polishing-fluid at high-pressure to a surface of the fuel cell separator body to which the gasket has been attached; (d) washing and drying the surface of the fuel cell separator body subjected to the high-pressure injection based surface polishing; and (e) performing vision inspection on the washed and dried surface of the fuel cell separator body using a vision camera.

In one implementation, the polishing-fluid includes a fluid and a polishing material dispersed in the fluid, wherein the polishing material includes at least one selected from a group consisting of alumina (Al₂O₃), iron oxide (Fe₂O₃), titanium dioxide (TiO₂), sodium oxide (Na₂O), aluminum nitride (AlN), zirconia (ZrO₂), and silica (SiO).

In one implementation, a content of the polishing material is in a range of 0.1 to 30% by weight based on 100% by weight of the polishing-fluid.

In one implementation, the high-pressure injection based surface-polishing is performed for about 10 to 120 sec.

In one implementation, the high-pressure injection based surface-polishing apparatus using includes: a polishing-fluid injection nozzle mounted to be spaced apart from the fuel cell separator body for injecting the polishing-fluid to the surface of the fuel cell separator body; a polishing-fluid supply pipe for supplying the polishing fluid to the polishing-fluid injection nozzle; a pressing drive roller for pressing the fuel cell separator body; and a protective casing for protecting the polishing-fluid injection nozzle, the polishing-fluid supply pipe and the pressing drive roller.

In one implementation, the polishing-fluid injection nozzle includes: an upper polishing-fluid injection nozzle mounted so as to face and be spaced apart from a top face of the fuel cell separator body for injecting the polishing-fluid to the top face of the fuel cell separator body; and a lower polishing-fluid injection nozzle mounted so as to face and be spaced apart from a bottom face of the fuel cell separator body for injecting the polishing-fluid to the bottom face of the fuel cell separator body.

In one implementation, each of the upper and lower polishing-fluid injection nozzles injects the polishing-fluid at a pressure in a range of 0.3 to 5 kgf/cm².

In one implementation, the pressing drive roller includes: an upper pressing drive roller disposed on a top face of the fuel cell separator body; and a lower pressing drive roller disposed on a bottom face of the fuel cell separator body.

In one implementation, the fuel cell separator body is mechanically compressed by the upper and lower pressing drive rollers while the body is moving through a space between the upper and lower pressing drive rollers.

In one implementation, the upper pressing drive roller and the lower pressing drive roller are arranged to partially overlap each other in a plan view of the apparatus.

### Technical Effect

In accordance with the method for manufacturing a fuel cell separator having minimized surface defect via surface polishing using high-pressure injection according to the embodiment according to the present disclosure, surface polishing may be performed using a high-pressure injection scheme in which the polishing-fluid is injected at high-pressure through the polishing-fluid injection nozzle before the vision inspection, thereby minimizing the surface defects such as scratches, burrs, stains, or dents in the fuel cell separator body.

As a result, in accordance with the method for manufacturing a fuel cell separator having minimized surface defect via surface polishing using high-pressure injection according to the embodiment according to the present disclosure, the surface of the fuel cell separator body may be polished in the surface polishing manner using the pressure injection of the polishing-fluid such that the surface roughness may be controlled to be lowered to a value within about several pm and thus the surface may be modified to have hydrophilicity, and thus, the water discharge properties of the surface may be improved.

Further, in accordance with the method for manufacturing a fuel cell separator having minimized surface defect via surface polishing using high-pressure injection according to an embodiment according to the present disclosure, the fuel cell separator body may be subjected to the mechanical compression by the upper and lower pressing drive rollers, and thereby suppressing the springback-related defect of the fuel cell separator body.

Further, in accordance with the method for manufacturing a fuel cell separator having minimized surface defect via surface polishing using high-pressure injection according to an embodiment according to the present disclosure, the surface roughness of the body may be controlled to be lowered via the surface polishing using high-pressure injection, thereby lowering the glossiness of the surface of the fuel cell separator body. Thus, the surface defects of the surface of the body may be easily detected during vision inspection using a vision camera, resulting in improved inspection efficiency.

In addition, in accordance with the method for manufacturing a fuel cell separator having minimized surface defect via surface polishing using high-pressure injection according to an embodiment according to the present disclosure, the residual oxides remaining on the surface of the fuel cell separator body may be scraped off and removed therefrom by the polishing material in the polishing-fluid in the surface polishing process using high-pressure injection, so that the surface electrical resistance may be lowered, thereby improving conductivity of the surface of the body.

### BRIEF DESCRIPTION OF DRAWINGS

FIG. 1 is a process flow chart showing a method for manufacturing a fuel cell separator having minimized surface defects via surface polishing using high-pressure injection according to an embodiment according to the present disclosure.

FIG. 2 is a side perspective view showing a surface polishing apparatus using high-pressure injection according to the present disclosure.

FIG. 3 is a front perspective view showing a surface polishing apparatus using high-pressure injection according to the present disclosure.

FIG. 4 is a cross-sectional view showing a side cross-section of a surface polishing apparatus using high-pressure injection according to the present disclosure.

FIG. 5 is a cross-sectional view showing a front cross-section of a surface polishing apparatus using high-pressure injection according to the present disclosure.

FIG. 6 is a plan view showing a surface polishing apparatus using high-pressure injection according to the present disclosure.

FIG. 7 is a schematic diagram to illustrate a principle of water discharge improvement when performing surface polishing using high-pressure injection.

FIG. 8 is a schematic diagram for illustrating a principle of improving surface modification when performing surface polishing using high-pressure injection.

FIG. 9 is an image showing a hydrophilicity test result based on whether or not surface polishing using high-pressure injection is performed.

FIG. 10 is an image showing a result of surface defect inspection based on whether or not surface polishing using high-pressure injection is performed.

FIG. 11 is an actual image showing a fuel cell separator based on whether or not surface polishing using high-pressure injection is performed.

FIG. 12 is an enlarged image of a fuel cell separator based on whether or not surface polishing using high-pressure injection is performed.

FIG. 13 is a table showing results of surface contact resistance measurement before and after surface polishing using high-pressure injection.

### DETAILED DESCRIPTIONS

Advantages and features of the present disclosure, and a method of achieving the advantages and features will become apparent with reference to embodiments described later in detail together with the accompanying drawings. However, the present disclosure is not limited to the embodiments as disclosed below, but may be implemented in various different forms. Thus, these embodiments are set forth only to make the present disclosure complete, and to completely inform the scope of the present disclosure to those of ordinary skill in the technical field to which the present disclosure belongs, and the present disclosure is only defined by the scope of the claims. Like reference numerals refer to like elements throughout the disclosure.

Hereinafter, with reference to the accompanying drawings, a method for manufacturing a fuel cell separator having minimized surface defect via surface polishing using high-pressure injection according to a preferred embodiment according to the present disclosure will be described in detail as follows.

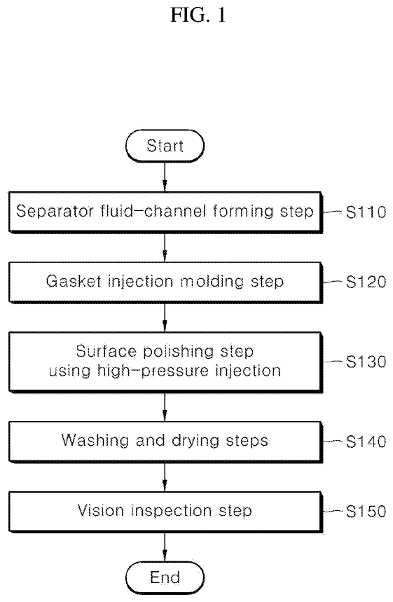

FIG. 1 is a process flow chart showing a method for manufacturing a fuel cell separator having minimized surface defects via surface polishing using high-pressure injection according to an embodiment according to the present disclosure.

As shown in FIG. 1, a method for manufacturing a fuel cell separator having minimized surface defect via surface polishing using high-pressure injection according to the embodiment according to the present disclosure includes a separator fluid-channel forming step S110, a gasket injection molding step S120, a surface polishing step using high-pressure injection S130, a washing and drying step S140, and a vision inspection step S150

### Separator Fluid-Channel Forming Step

In the separator fluid-channel forming step S110, a fuel cell separator body is shaped to form a reaction gas channel and a cooling water channel

In this step, a stamping scheme may be used for forming the separator fluid-channel However, the present disclosure is not limited thereto. Accordingly, the fuel cell separator body is formed as a rectangular metal plate in which a reaction gas channel and a cooling water channel are defined therein in an inner region thereof. In this regard, a combination of the reaction gas channel and the cooling water channel is referred to as a channel

The reaction gas channel is formed in the front face of the fuel cell separator body so as to protrude toward a rear face thereof, and the cooling water channel is formed in an area between the reaction gas channels and in the rear face of the fuel cell separator body.

### Gasket Injection Molding Step

In the gasket injection molding step S120, the fuel cell separator body in which the reaction gas channel and the cooling water channel are formed is subjected to a gasket injection molding step such that the gasket is attached to and along an edge of the fuel cell separator body.

In this regard, the gasket may be formed to surround the reaction gas channel and the cooling water channel, and may be made of a rubber material such as EPDM (ethylene propylene diene monomer).

Surface Polishing Step Using High-Pressure Injection

In the surface polishing step using high-pressure injection S130, a surface polishing apparatus using high-pressure injection injects polishing-fluid at high-pressure to the fuel cell separator body to which the gasket is attached.

In this regard, the polishing-fluid contains a polishing material and a fluid for dispersing the polishing material.

The polishing material includes at least one selected from alumina (Al₂O₃), iron oxide (Fe₂O₃), titanium dioxide (TiO₂), sodium oxide (Na₂O), aluminum nitride (AlN), zirconia (ZrO₂), and silica (SiO).

The polishing material may be preferably added at a content in a range of 0.1 to 30% by weight, more preferably, in a range of 3 to 20% by weight, based on 100% by weight of the polishing-fluid.

When the content of the polishing material is smaller than 0.1% by weight, it is difficult to properly exhibit the surface polishing effect because an amount of the polishing material is too small. Conversely, when the content of the polishing material exceeds 30 wt %, there is a risk of increasing a process cost due to an increase in the amount of the polishing material used without further increasing the effect.

In addition, industrial water may be used as the fluid. However, this is only an example. A type of the fluid is not particularly limited as long as the fluid may disperse the polishing material therein.

In this step, the surface polishing using high-pressure injection is preferably performed for 10 to 120 sec, more preferably, 20 to 60 sec. When an execution duration of the surface polishing using high-pressure injection is smaller than 10 sec, the surface defects such as burrs, stains, dents, and scratches that inevitably occur in the fuel cell separator body in the separator fluid-channel molding step S110 and the gasket injection molding step S120 may not be properly removed. Conversely, when the execution duration of the surface polishing exceeds 120 sec, this is not preferable because this may cause scratches on the fuel cell separator body due to excessive surface polishing.

Hereinafter, with reference to the accompanying drawings, the surface polishing apparatus using high-pressure injection used in the surface polishing step S130 using high-pressure injection will be described in more detail.

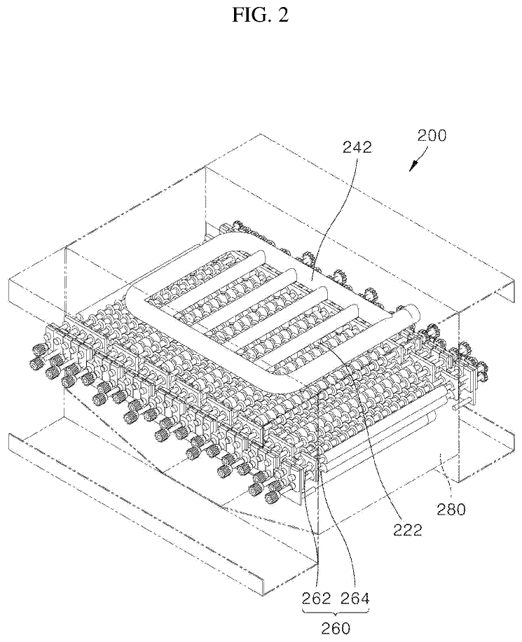

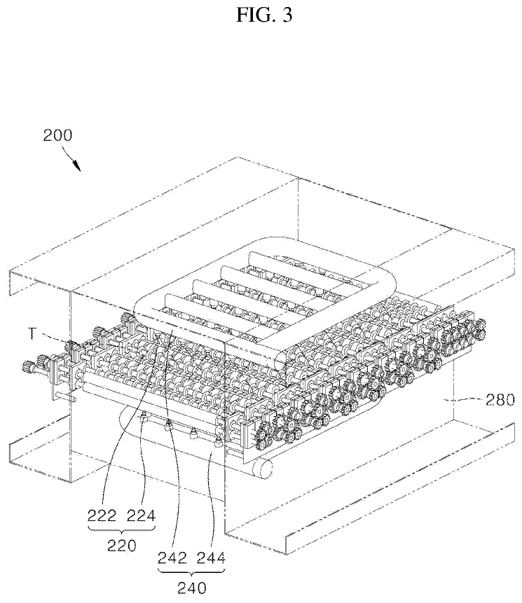

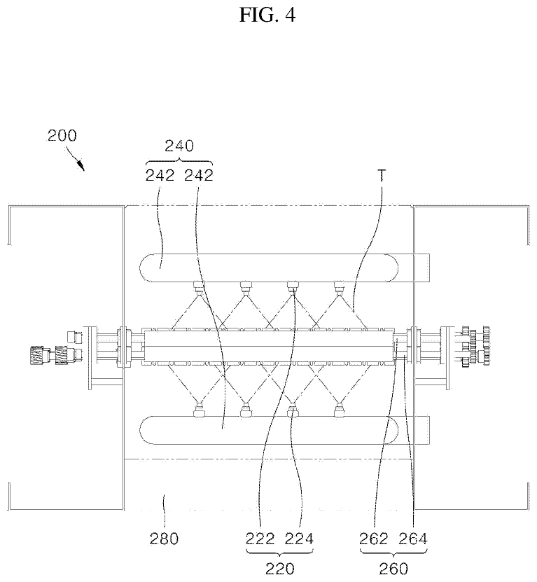

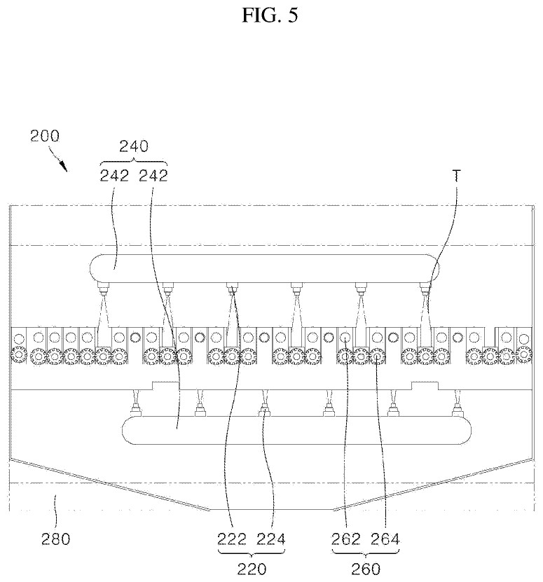

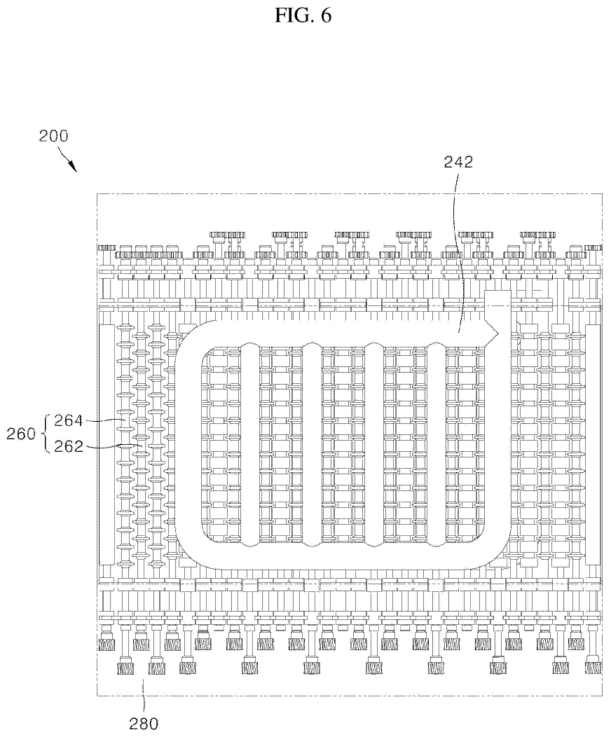

FIG. 2 is a side perspective view showing the high-pressure injection surface polishing apparatus according to the present disclosure. FIG. 3 is front a perspective view showing the surface polishing apparatus using high-pressure injection according to the present disclosure. FIG. 4 is a cross-sectional view showing a side cross-section of the surface polishing apparatus using high-pressure injection according to the present disclosure. FIG. 5 is a cross-sectional view showing a front cross-section of the surface polishing apparatus using high-pressure injection according to the present disclosure. FIG. 6 is a plan view showing the surface polishing apparatus using high-pressure injection according to the present disclosure. FIG. 2 to FIG. 6 will be described in conjunction with FIG. 1.

As shown in FIG. 1 to FIG. 6, a surface polishing apparatus using high-pressure injection 200 according to the present disclosure includes a polishing-fluid injection nozzle 220, a polishing-fluid supply pipe 240, a pressing drive roller 260 and a protective casing 280.

The polishing-fluid injection nozzle 220 is mounted to be spaced apart from the fuel cell separator body, and is mounted to inject the polishing-fluid T to the surface of the fuel cell separator body.

In this regard, the polishing-fluid injection nozzle 220 is mounted to be spaced apart from the fuel cell separator body so as to inject the polishing-fluid T at high-pressure on each of top and bottom faces of the fuel cell separator body to which the gasket is attached. That is, each polishing-fluid injection nozzle 220 is spaced from each of the top and bottom faces of the fuel cell separator body.

To this end, the polishing-fluid injection nozzle 220 includes an upper polishing-fluid injection nozzle 222 mounted so as to face and be spaced apart from the top face of the fuel cell separator body to inject the polishing-fluid T to the top face of the fuel cell separator body, and a lower polishing-fluid injection nozzle 224 mounted so as to face and be spaced apart from the bottom face of the fuel cell separator body to inject the polishing-fluid T to the bottom face of the fuel cell separator body.

Each of the upper and lower polishing-fluid injection nozzles 222 and 224 may inject the polishing-fluid T preferably at a pressure of 0.3 to 5 kgf/cm², more preferably at a pressure of 1 to 3 kgf/cm².

When the injection pressure of the polishing-fluid T is lower than 0.3 kgf/cm², the surface polishing effect on the fuel cell separator body is poor, making it difficult to properly reduce the surface roughness, such that the surface defects such as burrs, stains, dents, and scratches may not be reliably removed. Conversely, when the injection pressure of the polishing-fluid T exceeds 5 kgf/cm², this is not preferable because there is a risk of scratching the fuel cell separator body due to excessive surface polishing of the fuel cell separator body.

The polishing-fluid supply pipe 240 is mounted so as to supply the polishing-fluid T to the polishing-fluid injection nozzle 220. The polishing-fluid supply pipe 240 may receive the polishing-fluid T from a polishing-fluid supply tank and may supply the polishing-fluid T to the polishing-fluid injection nozzle 220.

In this regard, the polishing-fluid supply pipe 240 includes an upper polishing-fluid supply pipe 242 coupled to the upper polishing-fluid injection nozzle 222 so as to supply the polishing-fluid T to the upper polishing-fluid injection nozzle 222, and a lower polishing-fluid supply pipe 244 coupled to the lower polishing-fluid injection nozzle 224) so as to supply the polishing-fluid T to the lower polishing-fluid injection nozzle 224.

A pressing drive roller 260 is mounted to press the fuel cell separator body.

The pressing drive roller 260 includes an upper pressing drive roller 262 disposed on the top face of the fuel cell separator body, and a lower pressing drive roller 264 disposed on the bottom face of the fuel cell separator body.

Accordingly, the fuel cell separator body according to the present disclosure is mechanically compressed by the upper and lower pressing drive rollers 262 and 264 while the body is passing through a space between the upper and lower pressing drive rollers 262 and 264.

In this regard, the upper pressing drive roller 262 and the lower pressing drive roller 264 are preferably arranged to partially overlap each other in a plan view. This is to improve compression efficiency by maximizing a contact area of each of the upper pressing drive roller 262 and the lower pressing drive roller 264 with the fuel cell separator body passing through the space between the upper and lower pressing drive rollers 262 and 264.

Therefore, in the surface polishing step S130 using high-pressure injection according to the present disclosure, chemical surface polishing of injecting the polishing-fluid T to the surface of the fuel cell separator body using the polishing-fluid injection nozzle 220 and mechanical surface polishing of physically pressing the surface of the fuel cell separator body using the pressing drive roller 260 may be performed at the same time.

As a result, the apparatus in accordance with the present disclosure may mechanically press each of the top and bottom faces of the fuel cell separator body using each of the upper and lower pressing drive rollers 262 and 264 such that a certain tension may be applied to an edge portion of the fuel cell separator body, thereby suppressing a springback related defect of the fuel cell separator body.

The protective casing 280 is mounted to protect the polishing-fluid injection nozzle 220, the polishing-fluid supply pipe 240 and the pressing drive roller 260. The protective casing 280 may be made of a transparent plastic material. However, the present disclosure is not limited thereto.

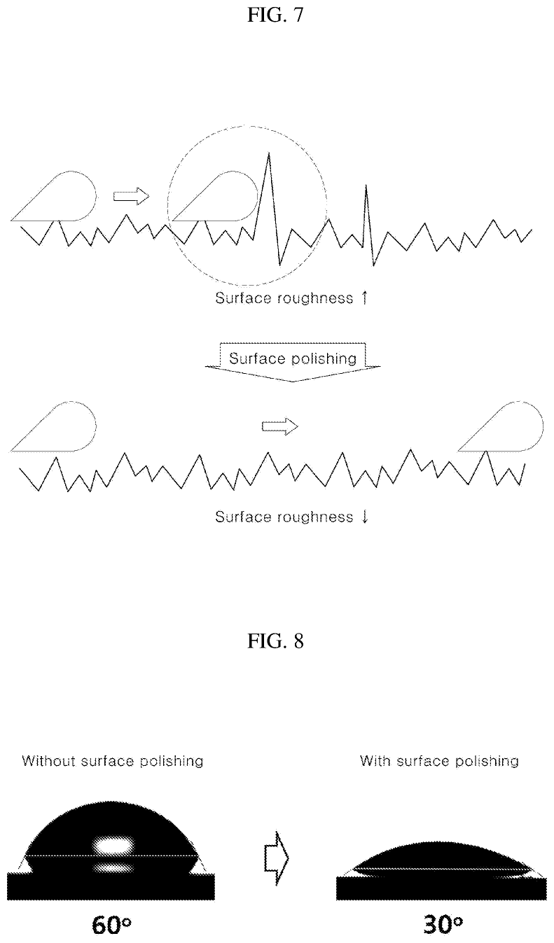

FIG. 7 is a schematic diagram to illustrate a principle of improving water discharge ability when surface polishing using high-pressure injection is performed. FIG. 8 is a schematic diagram for illustrating a principle of improvement of surface modification when performing surface polishing using high-pressure injection.

As shown in FIG. 7 and FIG. 8, when performing surface polishing using high-pressure injection of the polishing-fluid onto the surface of the fuel cell separator body, the surface is polished by the polishing material in the polishing-fluid such that the surface roughness is controlled to be lowered to a value of about several pm. Thus, the surface modification may be made such that the surface has hydrophilicity, and thus the water discharge ability may be improved.

As shown in FIG. 8, when the surface of the fuel cell separator body is subjected to surface polishing using high-pressure injection of the polishing-fluid to the surface thereof, a contact angle thereof may be lowered such that the surface may be modified so as to have hydrophilicity.

Further, since the surface is modified by performing the surface polishing using high-pressure injection, a process of pickling and degreasing the fuel cell separator body may be replaced with the surface polishing using high-pressure injection. Thus, the process of pickling and degreasing the fuel cell separator body may be omitted.

In addition, the surface polishing using high-pressure injection may control the surface roughness to be lower such that the glossiness of the fuel cell separator body may be lowered, making it possible to easily detect the surface defects during the vision inspection using a vision camera. Thus, the inspection efficiency may be improved.

In addition, in the surface polishing process using high-pressure injection, residual oxides remaining on the surface of the fuel cell separator body may be scraped off and removed by the polishing material in the polishing-fluid, so that the surface resistance may be lowered, thereby improving the conductivity.

As a result, according to the method for manufacturing the fuel cell separator that minimizes surface defects via surface polishing using high-pressure injection according to the present disclosure, the surface defect of the fuel cell separator body may be minimized by performing the surface polishing using high-pressure injection of the polishing-fluid onto the surface, thereby improving the water discharge ability and reducing the springback related defect, as well as lowering the surface roughness to lower the gloss of the surface, thereby easily detecting the surface defects during vision inspection using a vision camera, thereby improving inspection efficiency.

### Washing and Drying Step

In the washing and drying step S140, the surface of the fuel cell separator body subjected to the surface polishing using high-pressure injection is washed and dried.

In this regard, the washing is performed to remove foreign substances remaining on the fuel cell separator body by injecting industrial water thereto. Such washing is performed at least once or more, more preferably, 2 to 4 times.

In addition, the drying may be carried out in a manner of injecting air to the surface with an air gun.

In accordance with the present disclosure, in a state in which the surface defects such as burrs, stains, dents, and scratches are minimized by performing the surface polishing using high-pressure injection thereon, the washing and drying process is carried out. Thus, the rubber pieces resulting from the burr may not fly in the washing and drying process.

### Vision Inspection Step

In the vision inspection step S150, the washed and dried surface of fuel cell separator body is subjected to vision inspection using a vision camera.

In general, since the fuel cell separator body is made of a metal material, the surface has high gloss and reflects light therefrom, so that it is difficult to detect the surface defects such as burrs, stains, dents, and scratches using the vision camera.

In contrast, in accordance with the present disclosure, the performing of the surface polishing on the surface of the fuel cell separator body using high-pressure injection may allow the average surface roughness of the fuel cell separator body to be controlled to be lowered to a value within approximately several μm.

The surface polishing using high-pressure injection may control the surface roughness to be lower such that the glossiness of the fuel cell separator body may be lowered, making it possible to easily detect the surface defects during vision inspection using the vision camera, thereby improving the inspection efficiency.

In accordance with the method for manufacturing a fuel cell separator having minimized surface defect via surface polishing using high-pressure injection according to the embodiment according to the present disclosure, surface polishing may be performed using a high-pressure injection scheme in which the polishing-fluid is injected at high-pressure through the polishing-fluid injection nozzle before the vision inspection, thereby minimizing the surface defects such as scratches, burrs, stains, or dents in the fuel cell separator body.

As a result, in accordance with the method for manufacturing a fuel cell separator having minimized surface defect via surface polishing using high-pressure injection according to the embodiment according to the present disclosure, the surface of the fuel cell separator body may be polished in the surface polishing manner using the pressure injection of the polishing-fluid such that the surface roughness may be controlled to be lowered to a value within about several pm and thus the surface may be modified to have hydrophilicity, and thus, the water discharge properties of the surface may be improved.

Further, in accordance with the method for manufacturing a fuel cell separator having minimized surface defect via surface polishing using high-pressure injection according to an embodiment according to the present disclosure, the fuel cell separator body may be subjected to the mechanical compression by the upper and lower pressing drive rollers, and thereby suppressing the springback-related defect of the fuel cell separator body.

Further, in accordance with the method for manufacturing a fuel cell separator having minimized surface defect via surface polishing using high-pressure injection according to an embodiment according to the present disclosure, the surface roughness of the body may be controlled to be lowered via the surface polishing using high-pressure injection, thereby lowering the glossiness of the surface of the fuel cell separator body. Thus, the surface defects of the surface of the body may be easily detected during vision inspection using a vision camera, resulting in improved inspection efficiency.

In addition, in accordance with the method for manufacturing a fuel cell separator having minimized surface defect via surface polishing using high-pressure injection according to an embodiment according to the present disclosure, the residual oxides remaining on the surface of the fuel cell separator body may be scraped off and removed therefrom by the polishing material in the polishing-fluid in the surface polishing process using high-pressure injection, so that the surface electrical resistance may be lowered, thereby improving conductivity of the surface of the body.

### Example

Hereinafter, a configuration and an operation of the method and the apparatus according to the present disclosure will be described in more detail based on a preferred Example according to the present disclosure. However, a following example is presented as a preferable example according to the present disclosure, and should not be construed as limiting the present disclosure in any way.

Contents not described herein will be omitted because those may be technically inferred sufficiently by those skilled in the art.

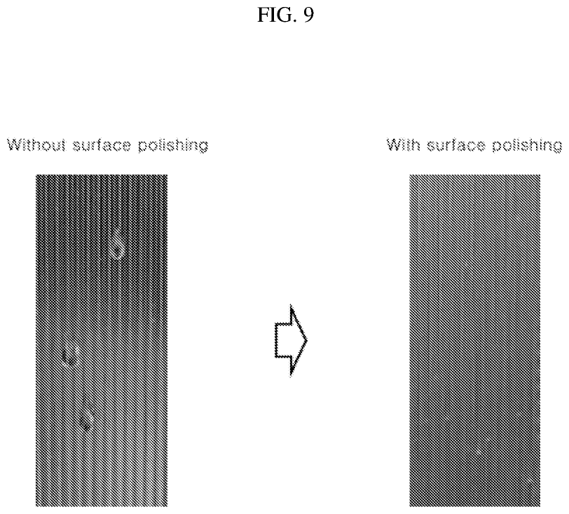

FIG. 9 is an image showing a hydrophilicity test result based on whether surface polishing using high-pressure injection is performed. In this regard, the surface polishing using high-pressure injection of the polishing-fluid containing alumina (Al₂O₃) as the polishing material was performed on the fuel cell separator body to which the gasket was attached. At this time, the polishing-fluid was injected through the polishing-fluid injection nozzle at a high pressure of 2 kgf/cm² for 30 sec.

As shown in FIG. 9, it was identified that some droplets remained on the surface of the body that was not subjected to the surface polishing using high-pressure injection, while no droplets remained on the surface of the body that has been subjected to the surface polishing using high-pressure injection. Thus, it was identified that when the surface polishing using high-pressure injection of the polishing-fluid was carried out on the surface of the body, the water discharge ability of the surface of the body was improved.

As described above, it was identified that when the surface polishing using high-pressure injection was performed, the water discharge property of the surface of the fuel cell separator was improved.

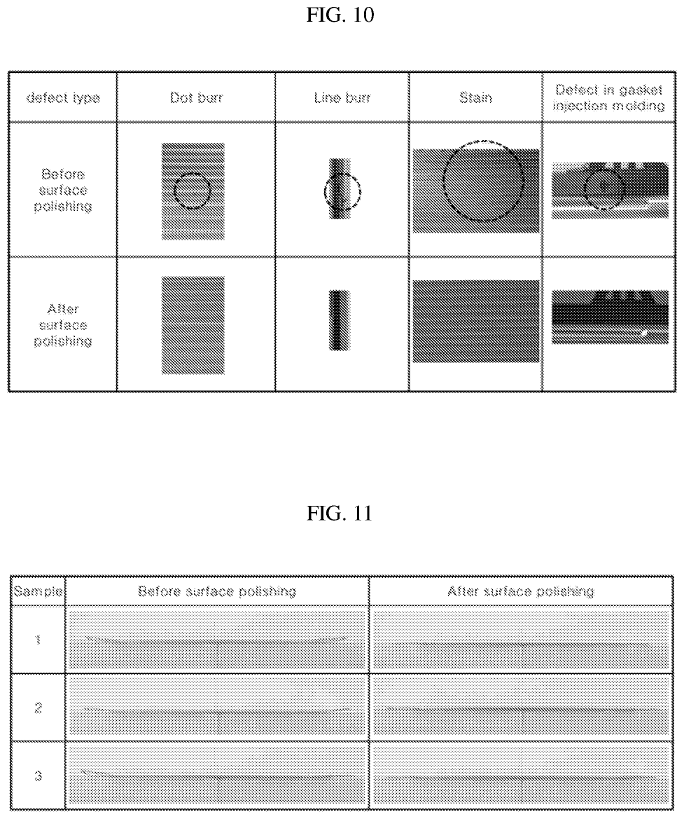

FIG. 10 is an image showing a result of surface defect inspection based on whether surface polishing using high-pressure injection is performed. As shown in FIG. 10, it may be identified that a surface stain, a dot burr, and a line burr are partially removed under the chemical and mechanical polishing via the surface polishing using high-pressure injection.

FIG. 11 is an image showing a fuel cell separator based on whether surface polishing using high-pressure injection is performed thereon.

As shown in FIG. 11, it may be identified that when the separator is subjected to the surface polishing using high-pressure injection, the separator is subjected to the mechanical compression by the upper and lower pressing drive rollers such that a bent portion of an edge is flattened without damage thereto, and thus the springback-related defect is reduced.

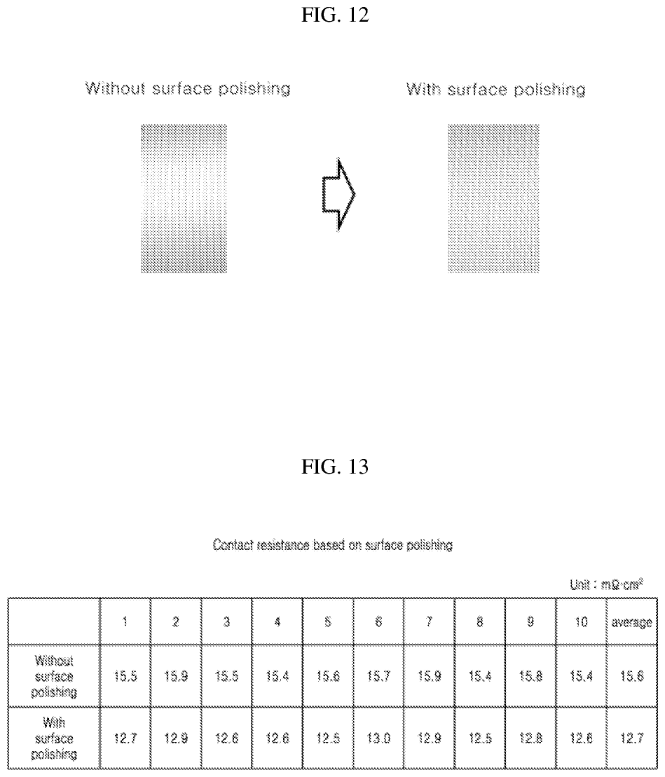

FIG. 12 is an enlarged image of the fuel cell separator based on whether surface polishing using high-pressure injection is performed thereon. In this regard, a left side of FIG. 12 is an actual image showing the fuel cell separator in a state before the surface polishing using high-pressure injection, while a right side of FIG. 12 is an actual image showing the fuel cell separator in a state after the surface polishing using high-pressure injection.

As shown in FIG. 12, it may be identified that light reflection from the surface is reduced due to the lowered surface roughness after the surface polishing using high-pressure injection, compared with that before the surface polishing using high-pressure injection.

Accordingly, during the vision inspection using the vision camera, an inspector may easily inspect the surface defects, and may have lowered eye fatigue such that the inspection reliability may be improved.

FIG. 13 is a table showing results of surface contact resistance measurement before and after surface polishing using high-pressure injection.

As shown in FIG. 13, it may be identified that the surface contact resistance is lowered by about 3 mΩ·cm², and the conductivity thereof is increased by 20% after the surface polishing using high-pressure injection, compared with those before the surface polishing using high-pressure injection.

Although the embodiment according to the present disclosure has been mainly described, various changes or modifications may be made thereto by a person skilled in the art in the technical field to which the present disclosure belongs. Such changes and modifications may belong to the present disclosure as long as they do not depart from the scope of the technical idea of the present disclosure. Therefore, the scope of rights according to the present disclosure should be determined based on the claims as described below.

### REFERENCE NUMERALS

S110: Separator fluid-channel forming step
S120: Gasket injection molding step
S130: Surface polishing step using high-pressure injection
S140: Washing and drying steps
S150: Vision inspection step

What is claimed is:

1. A method for manufacturing a fuel cell separator having minimized surface defect via surface polishing using high-pressure injection, the method comprising:
(a) shaping a fuel cell separator body to form a reaction gas channel and a cooling water channel defined in the body;
(b) performing gasket injection molding on the fuel cell separator body having the reaction gas channel and the cooling water channel defined therein such that a gasket is attached to and disposed along an edge of the fuel cell separator body;
(c) performing high-pressure injection based surface-polishing using a high-pressure injection based surface-polishing apparatus to inject a polishing-fluid at high-pressure to a surface of the fuel cell separator body to which the gasket has been attached;
(d) washing and drying the surface of the fuel cell separator body subjected to the high-pressure injection based surface polishing; and
(e) performing vision inspection on the washed and dried surface of the fuel cell separator body using a vision camera.

2. A method of claim 1, wherein the polishing-fluid includes a fluid and a polishing material dispersed in the fluid, wherein the polishing material includes at least one selected from a group consisting of alumina (Al₂O₃), iron oxide (Fe₂O₃), titanium dioxide (TiO₂), sodium oxide (Na₂O), aluminum nitride (AlN), zirconia (ZrO₂), and silica (SiO).

3. The method of claim 2, wherein a content of the polishing material is in a range of 0.1 to 30% by weight based on 100% by weight of the polishing-fluid.

4. The method of claim 1, wherein the high-pressure injection based surface-polishing is performed for about 10 to 120 sec.

5. The method of claim 1, wherein the high-pressure injection based surface-polishing apparatus using includes:
a polishing-fluid injection nozzle mounted to be spaced apart from the fuel cell separator body for injecting the polishing-fluid to the surface of the fuel cell separator body;
a polishing-fluid supply pipe for supplying the polishing fluid to the polishing-fluid injection nozzle;
a pressing drive roller for pressing the fuel cell separator body; and
a protective casing for protecting the polishing-fluid injection nozzle, the polishing-fluid supply pipe, and the pressing drive roller.

6. The method of claim 5, wherein the polishing-fluid injection nozzle includes:
an upper polishing-fluid injection nozzle mounted so as to face and be spaced apart from a top face of the fuel cell separator body for injecting the polishing-fluid to the top face of the fuel cell separator body; and
a lower polishing-fluid injection nozzle mounted so as to face and be spaced apart from a bottom face of the fuel cell separator body for injecting the polishing-fluid to the bottom face of the fuel cell separator body.

7. The method of claim 6, wherein each of the upper and lower polishing-fluid injection nozzles injects the polishing-fluid at a pressure in a range of 0.3 to 5 kgf/cm².

8. The method of claim 5, wherein the pressing drive roller includes:
an upper pressing drive roller disposed on a top face of the fuel cell separator body; and
a lower pressing drive roller disposed on a bottom face of the fuel cell separator body.

9. The method of claim 8, wherein the fuel cell separator body is mechanically compressed by the upper and lower pressing drive rollers while the body is moving through a space between the upper and lower pressing drive rollers.

10. The method of claim 8, wherein the upper pressing drive roller and the lower pressing drive roller are arranged to partially overlap each other in a plan view of the apparatus.
